(19) United States
(12) Patent Application Publication
(10) Pub. No.: US 2015/0262196 A1
(43) Pub. Date: Sep. 17, 2015

(54) Electronic Financial/Economic Modeling Environment

(71) Applicant: Lucas Ernesto Wall, Vienna, VA (US)

(72) Inventor: Lucas Ernesto Wall, Vienna, VA (US)

(21) Appl. No.: 14/207,301

(22) Filed: Mar. 12, 2014

(51) Int. Cl. G06Q 30/02; G06F 17/30; G06Q 10/06

(52) U.S. Cl. CPC G06Q 30/0201; G06Q 10/067; G06F 17/30424

(57) ABSTRACT

Exemplary embodiments are directed to generating one or more financial/economic reports for a user based on one or more user-submitted parameters. Exemplary embodiments can generate location and data type (e.g., business type) specific reports that can include financial and/or economic information to aid in the user's decision making process (e.g., whether to acquire a business). In exemplary embodiments, optimized reports can be generated to identify different location that may provide a better purchasing opportunity for the user.

### BACKGROUND

In recent years, an overwhelming amount of data has been made available in electronic form from a large number of different data sources. Some people seeking to use this data in a meaningful way often cannot find the data they are looking or do not possess the skill or time necessary for interpreting the large volume of data available. As a result, it is becoming increasingly difficult for people to take advantage of the data that is available. Additionally, even with the abundance of data available to a person, the person may not have access to proprietary data compiled by one or more entities.

For example some interested in start, acquiring, and/or expanding a business may not have the necessary time and knowledge to develop a comprehensive view of the potential and possible pitfalls associated with starting, acquiring, and/or expanding a specific type of business in a specific geographic location or identify which geographic location would offer an advantage over another geographic location.

### SUMMARY

Exemplary embodiments of the present disclosure are directed to generating one or more financial/economic reports for a user based on one or more user-submitted parameters. Exemplary embodiments can generate location and data type (e.g., business type) specific reports that can include financial and/or economic information to aid in the user's decision making process (e.g., whether to acquire a business). In exemplary embodiments, optimized reports can be generated to identify different location that may provide a better purchasing opportunity for the user.

Exemplary embodiments advantageously provide an environment that presents and analyzes a large volume of data and provides an approach that associates or connects the data from different sources to provide a comprehensive and user friendly presentation of the data to allow a user to make an informative decision. In this regard, exemplary embodiments can leverage the vast amount of data to provide the user with a data type (e.g., business type) and location specific reports and can provide the user with the appropriate information in a manageable form. Moreover, exemplary embodiments can advantageously identify specific geographic locations for which the data is maximized or minimized relative to other geographic locations.

In one embodiment, a method for generating one or more electronic reports for a field of interest is disclosed. The method includes receiving parameters from a user. The parameters include a descriptive term for the field of interest and a location information for the field of interest. The method also includes identifying a field of interest by programmatically comparing the descriptive term to fields of interest in a database, converting the location information to a latitude value and longitude value to associate the location information with a geographic location, identifying other geographic locations within a specified distance of the geographic location based the latitude value and longitude value of the geographic location and a latitude value and longitude value of each of the other geographic locations, and programmatically generating at least one of a financial report or an economic report including at least one of historic data or projected data for the geographic location and the other geographic locations.

In another embodiment, a system for generating one or more electronic reports for a field of interest is disclosed. The system includes a non-transitory computer-readable media and a processing device. The non-transitory computer readable media stores instructions for generating at least one of a financial report or an economic report. The processing device is programmed to execute the instructions to receiving parameters from a user. The parameters include a descriptive term for the field of interest and a location information for the field of interest. The processing device is also programmed to execute the instructions to identify a field of interest by programmatically comparing the descriptive term to fields of interest in a database, convert the location information to a latitude value and longitude value to associate the location information with a geographic location, identifying other geographic locations within a specified distance of the geographic location based the latitude value and longitude value of the geographic location and a latitude value and longitude value of each of the other geographic locations, and programmatically generate at least one of a financial report or an economic report including at least one of historic data or projected data for the geographic location and the other geographic locations.

In yet another embodiment, a non-transitory computer-readable medium that stores instructions which are executable by a processing device is disclosed. Execution of the instructions by the processing device causes the processing device to perform a method for generating one or more electronic reports for a field of interest including reading instructions for receiving parameters from a user, reading instructions for identifying a field of interest by programmatically comparing the descriptive term to fields of interest in a database, reading instructions for converting the location information to a latitude value and longitude value to associate the location information with a geographic location, reading instructions for identifying other geographic locations within a specified distance of the geographic location based the latitude value and longitude value of the geographic location and a latitude value and longitude value of each of the other geographic locations, and reading instructions for programmatically generating at least one of a financial report or an economic report including at least one of historic data or projected data for the geographic location and the other geographic locations. The parameters include a descriptive term for the field of interest and a location information for the field of interest.

In some embodiments, other geographic locations within a specified distance of the geographic location are identified by identifying the other geographic locations in response to criteria associated with the data of the other geographic locations. In some embodiments, the other geographic locations that satisfy the criteria can be displayed to the user. In some embodiments, the data corresponds to sales data and the criteria corresponds to a threshold for the sales data. The other geographic locations that have sales data that is greater than the threshold can be displayed to the user. In some embodiments, the data corresponds to expenses data and the criteria corresponds to a threshold for the expenses data. The other geographic locations that have expenses data that is less than the threshold can be displayed to the user. In some embodiments, the data corresponds to acquisition cost data and the criteria corresponds to a threshold for the acquisition cost data. The other geographic locations that have acquisition cost data that is less than the threshold can be displayed to the user. In some embodiments, the data is associated with a return on investment and the criteria corresponds to a threshold for the data. The other geographic locations that have a return on investment that is greater than the threshold can be displayed to the user.

In some embodiments, it can be determined that the at least one of historic or project data is unavailable for the geographic location and the at least one of historic data or projected data for the geographic location can be programmatically generated based on data associated with at least one of a county within which the geographic location is located, a state within which the geographic location is located, a country within which the geographic location is located, or another geographic location located within a specified distance to the geographic location. In some embodiments, the at least one of historic data or projected data for the geographic location can be programmatically generated by performing a cost of living adjustment to the data associated with at least one of a county within which the geographic location is located, a state within which the geographic location is located, a country within which the geographic location is located, or another geographic location located within a specified distance to the geographic location. In some embodiments, it can be determined that the at least one of historic or project data is unavailable for the geographic location for one or more years and the at least one of historic data or projected data for the geographic location for the one or more years can be programmatically generated based on data associated with the geographic location for other years. In some embodiments, the at least one of historic data or projected data for the geographic location for the one or more years can be programmatically generated by performing an adjustment to the data associated with the geographic location for other years based on inflation.

Any combination of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of an exemplary financial/economic modeling environment in accordance with the present disclosure.

FIG. 2 is a block diagram of an exemplary economic modeling environment in accordance with the present disclosure.

FIGS. 3-7, FIGS. 8A-D, FIG. 9, and FIGS. 10A-H show exemplary graphical user interface(s) that can be generated and displayed by exemplary embodiment of the environment in accordance with the present disclosure.

FIG. 11 is a block diagram of an exemplary computing device for implementing embodiments of the present disclosure.

FIG. 12 is a block diagram of an exemplary client-server environment for implementing embodiments of the environment in accordance with the present disclosure.

### DESCRIPTION OF EXEMPLARY EMBODIMENTS

Exemplary embodiments of the present disclosure are directed to generating one or more financial/economic reports for a user based on one or more user-submitted parameters. Exemplary embodiments can generate location and data type (e.g., business type) specific reports that can include financial and/or economic information to aid in the user's decision making process (e.g., whether to acquire a business). In exemplary embodiments, optimized reports can be generated to identify different location that may provide a better purchasing opportunity for the user.

While the following disclosure generally illustrates an implementation of an exemplary embodiment of an economic modeling environment in the field of business investments (e.g., starting, acquiring, expanding, etc. a business), those skilled in the art will recognize that exemplary embodiments of the environment can advantageously be implemented in other fields in accordance with the present disclosure. For example, exemplary embodiments of the environment can also be implemented in, but not limited to the fields of real estate investments (e.g., residential or commercial property investments) and consumer/commercial purchase expenses (e.g., vehicle purchases).

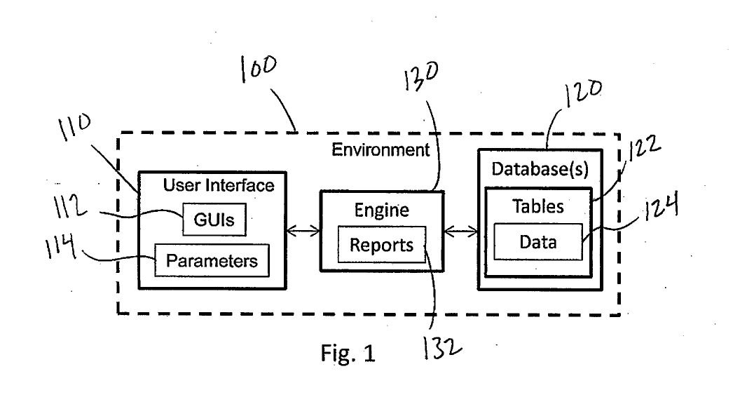

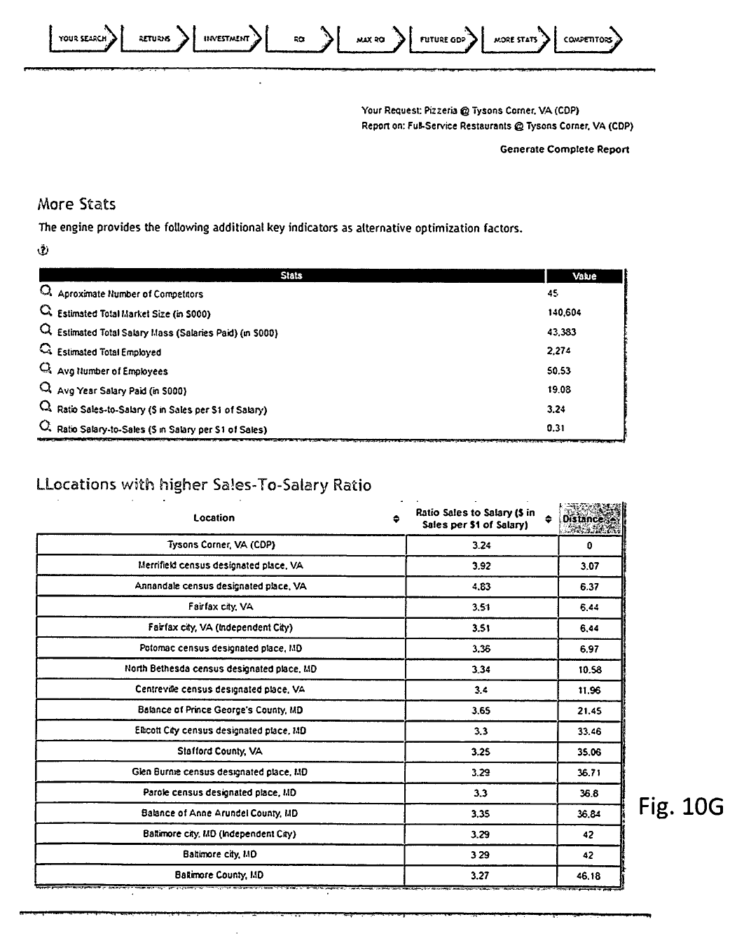

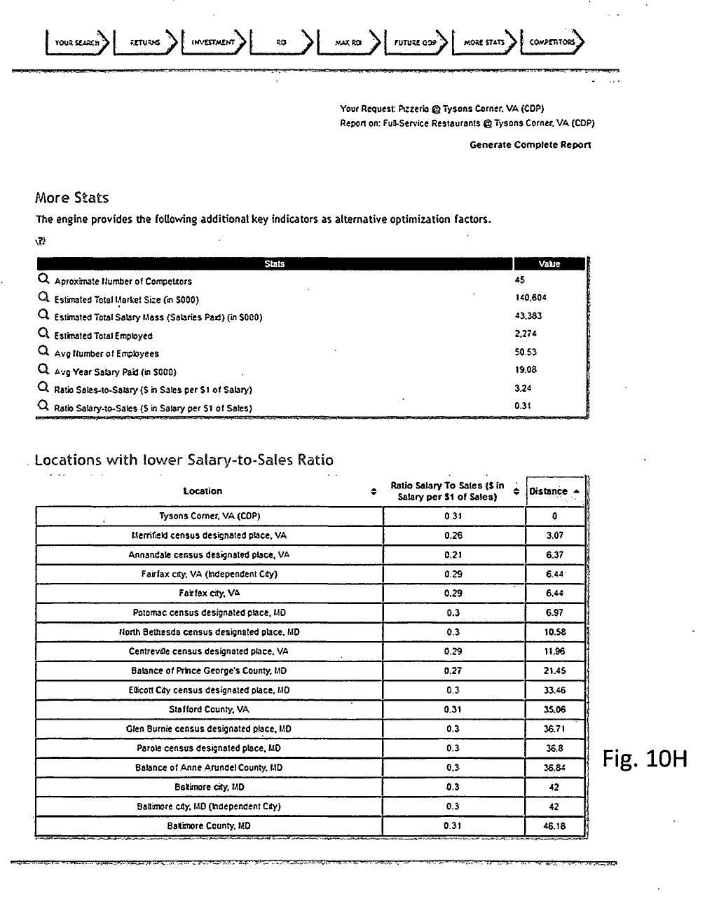

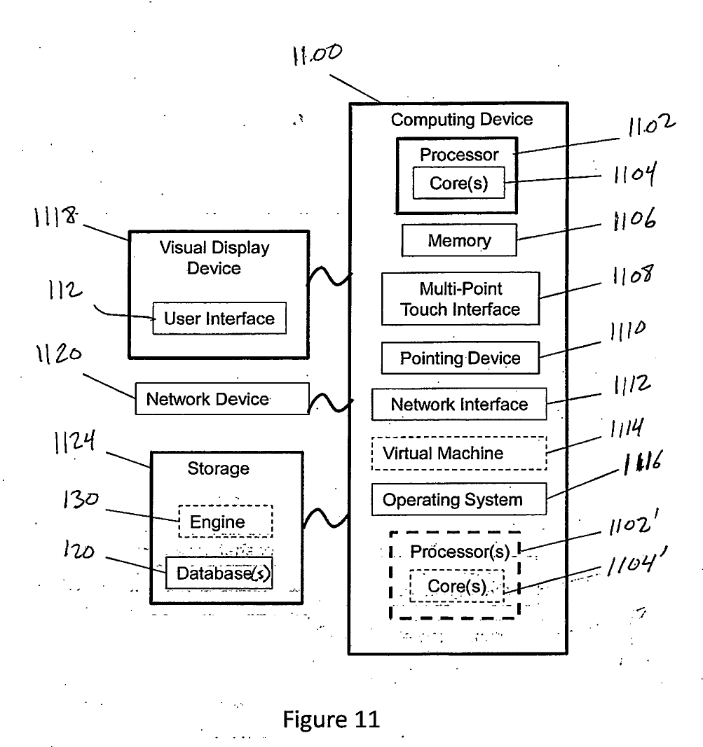

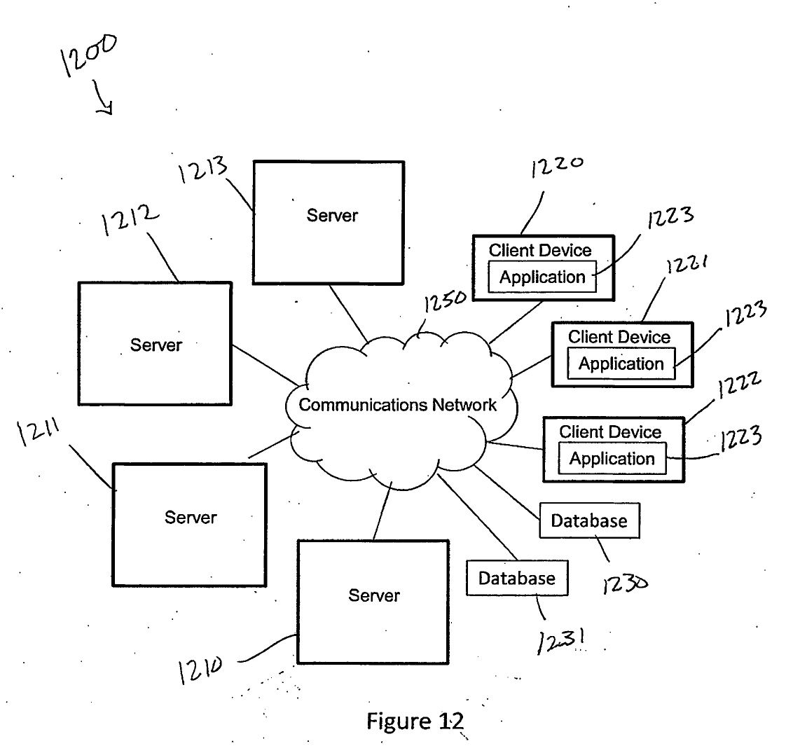

FIG. 1 is a block diagram of an exemplary economic modeling environment 100 (hereinafter “environment 100”). Exemplary embodiments of the environment 100 can be implemented using hardware, software, and/or a combination thereof. For example, in one exemplary embodiment, one or more computing devices, such as one or more client devices and/or one or more servers, can be configured to implement exemplary embodiments of the environment 100. Exemplary embodiments of a client device and/or a server programmed and/or configured to implement embodiments of the environment 100, or portions thereof, is shown, for example, in FIGS. 11 and 12. The environment 100 can include a user interface 110, one or more databases 120, and a report generation engine 130.

In exemplary embodiments, the user interface 110 can be programmed and/or include executable code to provide one or more graphical user interfaces (GUIs) 112 through which a user can interact with the environment 100. As an example, in some embodiments, the user interface 110 can be associated with one or more web pages and/or can be implemented as a client-side application, as discussed in more detail below with reference to FIG. 12. The GUIs 112 displayed to users can include data entry areas to receive information from the user and/or the user's computing device (e.g., a mobile phone with an enabled location service). The GUIs 112 can include data outputs to display information to the user. For example, one of the GUIs 112 can allow a user to enter parameters 114 that can be used by the engine 130 to generate one or more financial/economic reports for the user and/or to display data in response to the parameters 114. Some examples of parameters 114 include, but are not limited to location information (e.g., a city, state, town, county, zip code), business descriptions (e.g., key terms, a business type, a business industry), and/or any other suitable parameters to describe a set of user-specified parameters that can be used by the environment to generate one or more economic data reports. Some examples of data entry fields include, but are not limited to text boxes, check boxes, buttons, dropdown menus, and/or any other suitable data entry fields that can be populated manually by the user or programmatically by the user's device. In some embodiments, the user interface 110 can be programmed and/or include executable code to specify some of the search parameters 114 and/or to restrict a user's entries to choices specified by the user interface 110 (e.g., using a dropdown menu with environment specified parameters from which the user can select).

The one or more databases 120 can include one or more tables 122 of data 124 including, for example, geographic information, cost of living information (e.g., a cost of living index for one or more geographic areas), economic information (e.g., average revenue, average sales, average expenses, market size, etc., for one or more geographic areas and one or more business types), business information (cost of acquiring different types of businesses, rent expenditure, commercial real estate occupancy, businesses competitors, average number of employees, etc., for one or more geographic areas and one or more business types), and/or any other suitable data that can be used by the engine 130 for generating one or more financial reports. In exemplary embodiments, the data in the databases can be acquired from one or more data sources including, for example, the Internet, economic census, bureau of labor and statistics, brokerages, and/or any other suitable data source.

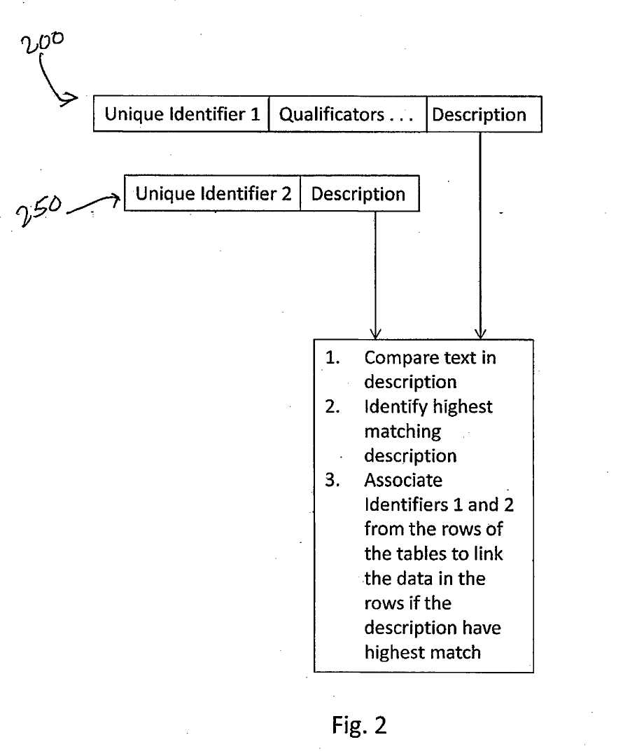

A significant amount of data from different data sources can be stored in the tables 122 and the environment 100 can be programmed and/or configured associate data in the different tables with each other to provide a mechanism for retrieving corresponding data from the different tables. For example, referring to FIG. 2, a first table 200 in one of the databases 120 can include a unique identifier, qualificators, and a description for each row of the first table 200. A second table 250 in one of the databases 120 can include a description and a unique identifier (different from the unique identifiers of the first table) for each row in the second table 250.

An issue that arises, and which the present disclosure address, is how to “link” of “connect” the data in first table 200 to the data in the second table so that the engine 130 can retrieve data from the first table and corresponding data from the second table. To link the data, the environment 100 can, for example, compare the text in the description fields in each table using semantic text indexing to identify descriptions having a specified similarity. For example, in one embodiment, the environment 100 can use duplet or triplet indexing, which truncates each text string or word in the descriptions to the first two or three letters, respectively. Each time there is a match between the two descriptions, the similarity between the description increases. The unique identifiers corresponding to the rows of the tables in which the descriptions exceed specified similarity level are associated with each other. The association between the unique identifiers is stored for future use. For example, when the engine 130 programmatically retrieves data from the first table 200, the engine 130 can use the unique identifiers from the data to retrieve the associated unique identifiers for the second table 250 and the engine can programmatically retrieve the data corresponding to the retrieved unique identifiers of the second table 250.

Generally, referring again to FIG. 1, some of the data sources used to generate the database 120 can associate the data with corresponding zip codes, city names, county names, street names, street intersections, street address, state names, and the like. The geographic information associated with the data acquired from these data sources can be processed when generating, updating, and/or modifying the tables of the databases 120 to associate the data with a corresponding latitude and longitude based on the geographic information from the data sources. For example, in some embodiments, one or more geographic services can be used to convert the geographic nomenclature in the data sources to a latitude and longitude. The latitude and longitude associated with the data can be stored with the data in tables of the database(s) 120. By associating the data in the database with a latitude and longitude, the environment 100 can provide an unambiguous geographic designation for the data and can provide a link between the tables based on, for example, the latitude and longitude or a unique identifier corresponding to the latitude and longitude such that data can be extracted from the tables based on a latitude and longitude.

The engine 130 can be programmed and/or configured to receive the parameters 114 from the user interface 110, execute one or more software procedures, and construct one or more queries based on the parameters. The parameters 114 can be received at various points in the report generate process. In some embodiments, the environment 100 can allow the user to input observed values for use by the engine 130. For example, in some embodiments, the user can enter data from his own business, a business the user is interested in buying, as well as any other data that can be used by the engine when generating the reports 132 (e.g., sales data, expenses data, acquisition cost data). For example, the engine 130 can be programmed to compare the user entered parameters 114 to the data provided by the engine 130. The one or more queries can be submitted to the one or more databases to retrieve data from the databases which can be processed by the engine 130 to generate one or more reports 132. In exemplary embodiments, the engine 130 can be programmed and/or configured to execute one or more algorithms to determine which data to retrieve from the databases 120 in response to the parameters 114 and/or to analyze the data retrieved from the databases 120. The algorithms can provide industry and/or geographic location specific reports to the user that can be customized by the user based on the parameters 114 submitted by the user.

The one or more reports 132 can be output to the user interface 110 by the engine 130 and the one or more reports can be displayed to the user via the GUIs 112. In exemplary embodiments, the one or more reports can include, for example, reports on cash flow, profits, return on investments, revenue, costs/expenses, gross domestic product, paybook periods, capital investment, comparable opportunities, acquisition costs, operational costs, and the like. In exemplary embodiments, the engine 130 can be programmed and/or configured to provide temporal and/or geographic location specific adjustments to the data in the databases to provide the reports 132 based on assumptions regarding, for example, inflation and/or a cost of living in a selected geographic location and/or other geographic locations within a specified distance of the selected geographic location.

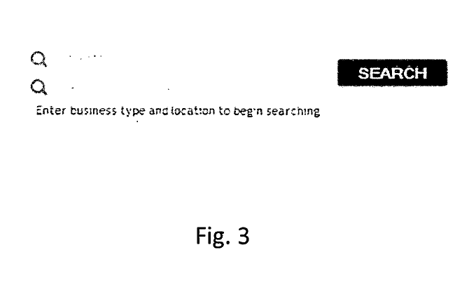

In an exemplary operation, the user can enter a business description and can enter location information in data entry fields of the GUI shown in FIG. 3. Once the user selects the search button, the user interface 110 can interface with the engine 130 to translate the business description and location information submitted as parameters 114 by the user. For example, in the present embodiment, the user can enter “pizzeria” as the business description and Tysons Corner, Va. as the location information. To translate the business description, the engine 130 uses semantic text indexing to correlate the business description with a business type. For example, in one embodiment, the engine 130 can use duplet or triplet text indexing to programmatically generate a score corresponding to the user entered description. The engine 130 can programmatically identify possible business industries corresponding to the entered description based on comparison of the generated score to associated data in one of the databases 120.

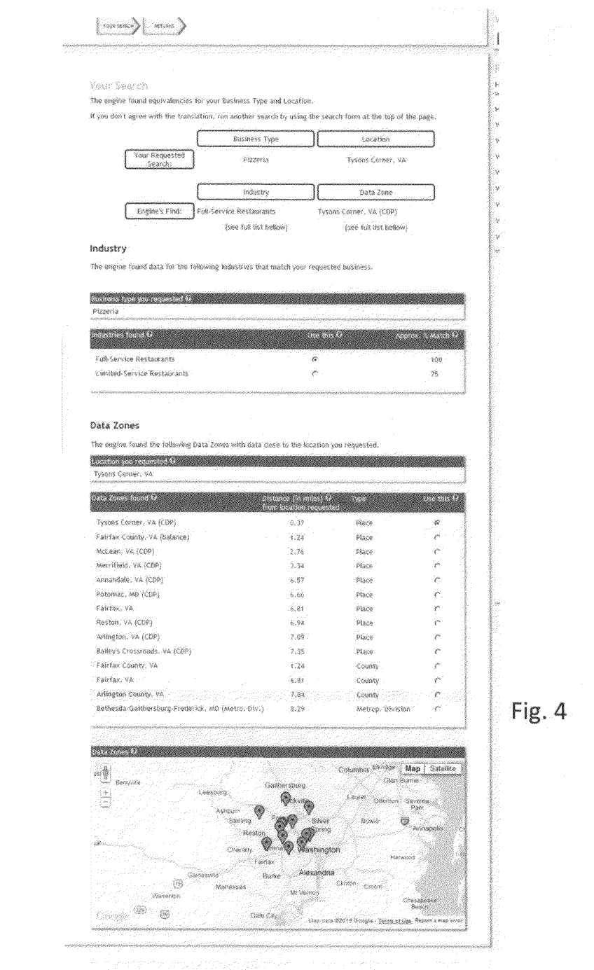

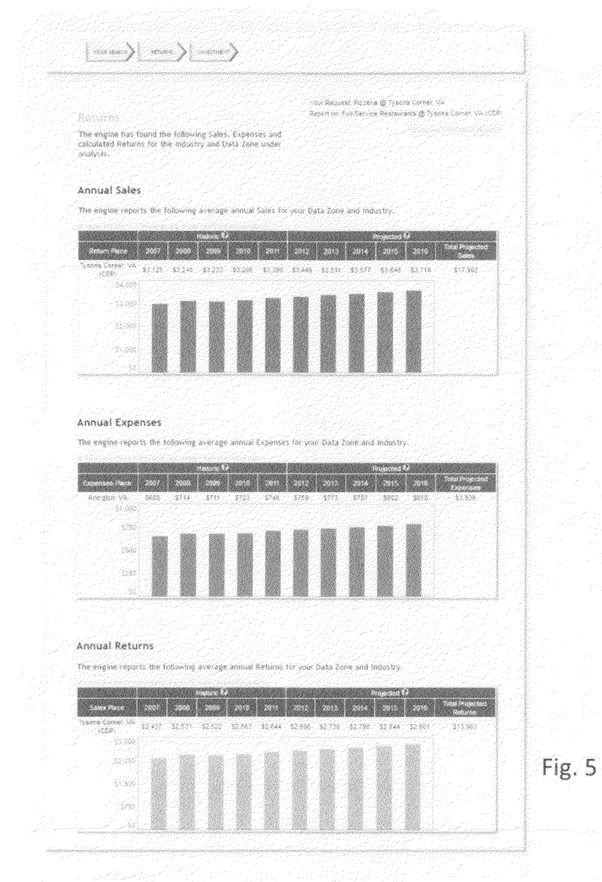

The engine 130 can retrieve the potential matches from the one of the databases 120 and returns them to the user for selection/approval. Exemplary results are provided in the below table, where column c1 identifies the closest and other business types that may correspond to the business description entered by the user, column c2 lists the business types identified, column c4 provides industry codes for the business types returned by the translator 132, and column c5 provides the approximate match to the description (where a one (1) corresponds to the best/closest match and low values correspond to less likely matches). A GUI showing the results is shown in FIG. 4.

| Id | c1 | c2 | c3 | c4 | c5 |
|---|---|---|---|---|---|
| 1 | Engine found | Full-Service | 58 | 722110 | 1 |
| | business group: | Restaurants | | | |
| 2 | Other business | Limited-Service | 44 | 722211 | 0.75862068 |
| | groups to consider: | Restaurants | | | |

To translate the location information, the user interface interfaces with the engine 130, which can call a location service to convert the location information entered by the user into a latitude and longitude. Using the latitude and longitude, the engine 130 can identify other geographic locations that are in geographic proximity to the submitted location. For example, the engine 130 can be programmed and/or configured to identify geographic locations that are within a specified distance (e.g., 5 mi., 10 mi., 15 mi., 50 mi., 100 mi., etc.) to the user-submitted location. In the present embodiment, the engine 130 can return a list of geographic locations to the user.

Exemplary geographic locations are provided in the below table, where column c1 list geographic locations according to their proximity to the location entered by the user, column c2 provides a geographic distance from closet matched location and the other returned locations, column c5 identifies the first and closest geographic location as the preferred one (e.g., by assigning a one (1) to it), but the environment 100 allows the user can change the default if desired, column c6 provides a unique code for each returned geographic location based on the latitude and longitude, and column c7 identifies the business type of interest. The columns 6 and 7 can be used by the engine 130 in subsequent steps. In exemplary embodiments, the distance between each location and the closet matched location can be calculated based on their associated latitude (column c4) and longitude (column c5). In addition to a list of locations, or in the alternative, a map including indicators to identify the returned locations can be provided to the user. Each indicator in the map can be selectable to show the name from (e.g., from column c1) and the distance from the requested location (e.g., from column c2). A GUI showing the results is shown in FIG. 4.

| Id | c1 | c2 | c3 | c4 | c5 | c6 | c7 |
|---|---|---|---|---|---|---|---|
| 1 | Tysons Corner census | 0 | 38.9187222 | −77.2310925 | 1 | E6000US5105979952 | 722110 |
| | designated place, VA | | | | | | |
| 2 | Balance of Fairfax County, | 0.866322 | 38.9085472 | −77.2405153 | 0 | E6000US5105998059 | 722110 |
| | VA | | | | | | |
| 3 | Merrifield census designated | 3.07397 | 38.8742785 | −77.2269262 | 0 | E6000US5105951192 | 722110 |
| | place, VA | | | | | | |
| 4 | McLean census designated | 3.08163 | 38.9342776 | −77.1774801 | 0 | E6000US5105948376 | 722110 |
| | place, VA | | | | | | |
| 5 | Annandale census designated | 6.37432 | 38.8303905 | −77.1963703 | 0 | E6000US5105901912 | 722110 |
| | place, VA | | | | | | |
| 6 | Reston census designated | 6.85648 | 38.9687213 | −77.3410958 | 0 | E6000US5105966672 | 722110 |
| | place, VA | | | | | | |
| 7 | Potomac census designated | 6.96591 | 39.0181651 | −77.2085914 | 0 | E6000US2403163300 | 722110 |
| | place, MD | | | | | | |
| 8 | Arlington census designated | 7.21489 | 38.8799697 | −77.1067698 | 0 | E6000US5101303000 | 722110 |
| | place, VA | | | | | | |
| 9 | Bailey's Crossroads census | 7.34712 | 6 38.848033 | −77.12916 3 | 0 | E6000US5105904088 | 722110 |
| | designated place, VA | | | | | | |
| 10 | Bethesda census designated | 8.24171 | 38.9806658 | −77.100256 | 0 | E6000US2403107125 | 722110 |
| | place, MD | | | | | | |
| 11 | Springfield census designated | 9.23741 | 38.7892801 | −77.1872036 | 0 | E6000US5105974592 | 722110 |
| | place, VA | | | | | | |

As shown in FIG. 4, the engine 130 can be programmed to provide the business type “Full Service Restaurants” and the location “Tysons Corner, Va.” as defaults that can be changed by selecting the radial buttons. Once the user selects, the “Returns” button, the engine 130 can be programmed to use the unique industry code corresponding to the selected “Full Service Restaurant” business type and the unique location identifier corresponding to the selected “Tysons Corner, Va.” location to retrieve historic and projected average annual sales and average annual expenses and to calculate the average annual returns based on the sales and expenses (e.g., Returns=Sales−Expenses). In some embodiments, average sale data for the selected business industry and average expenses data can be provided for a preceding five (5) year period and for a project five (5) year period. A GUI including the historic and projected sales, expenses, and returns data is shown in FIG. 5.

The average annual sales can be inflation adjusted. The average annual expenses can be inflation adjusted and adjusted for the cost of living. In exemplary embodiments, if there is no sales data in one of the databases 120 for the selected location (e.g., Tysons Corner), the engine 130 can attempt to identify a geographic location in proximity to the select location for which such data is available based on a latitude and longitude and can use available data from the nearest geographic location. Additionally, or in the alternative, if the engine 130 does not identify sales data for one of the years, the engine 130 can programmatically and dynamically identify sales data in a table of one of the databases 120 and can estimate the sales data based on one or more assumptions. For example, the sales data from another year to be used for the year which does not have sales data can be adjusted for inflation.

In exemplary embodiments, the average annual expenses data can be derived by the engine 130 from expenses data at the state and/or country level. The engine 130 can dynamically apply the state/country expenses data to a geographic location based on a cost of living index associated with the selected geographical location. In some embodiments, cost of living information may not be available for the selected geographic location (e.g., Tysons Corner). In such instances, the engine 130 can programmatically identify the nearest geographic location to the selected location (e.g., Arlington, Va.) for which the cost of living information is available and can dynamically adjust the state/country expenses data to reflect the cost of living at the nearest geographic location. The nearest geographic location can be determined based on a latitude and longitude of the geographic locations.

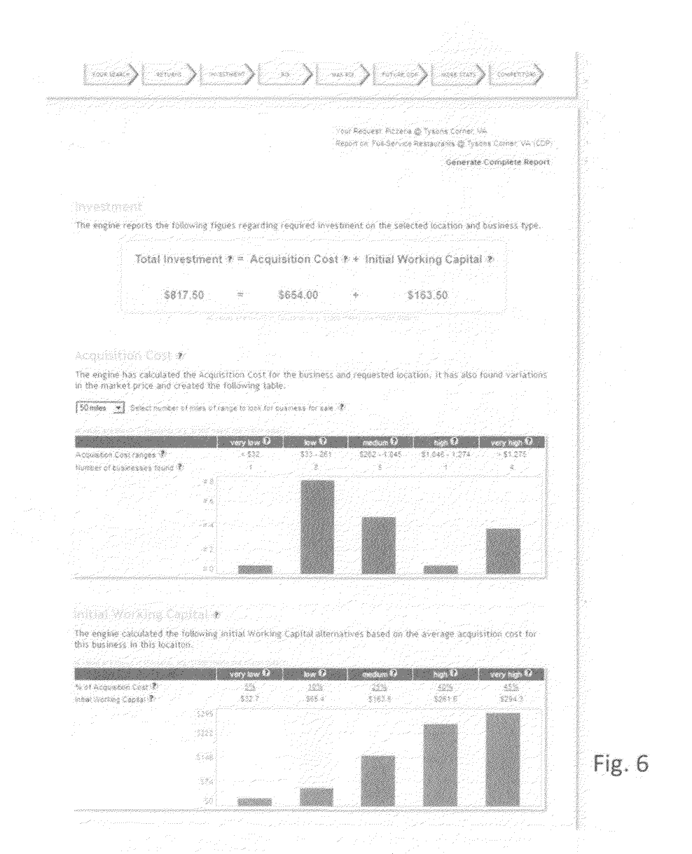

The user can continue interacting with the environment 100, by selecting the “Investment” button. In response to selection of the “Investment” button, the engine 130 can be programmed to compute a total investment cost corresponding to the business type and selected geographic location (Total investment=Acquisition Cost+Initial Working Capital). The engine 130 can access one of the databases 120 to retrieve data corresponding to the acquisition cost based on a latitude and longitude of the selected location. A GUI showing the Total Investment, Acquisition Cost, and Initial Working Capital is shown in FIG. 6.

To compute the total investment cost, the engine 130 can be programmed to use default assumptions regarding some parameters used to determine the acquisition cost for a business within the selected business type and an initial working capital required. As one example, the acquisition cost can be determined based on the cost acquiring business of the selected business type within a radius having a default distance of 50 miles around the selected location. The user can adjust the radius by selecting the dropdown menu shown in the GUI of FIG. 6. As another example, the initial working capital can be determined based on a percentage of the acquisition cost and can default to 25%. The user can adjust the percentage by selecting another percentage shown in FIG. 5 (e.g., 5%, 10%, 40%, 45%, etc.).

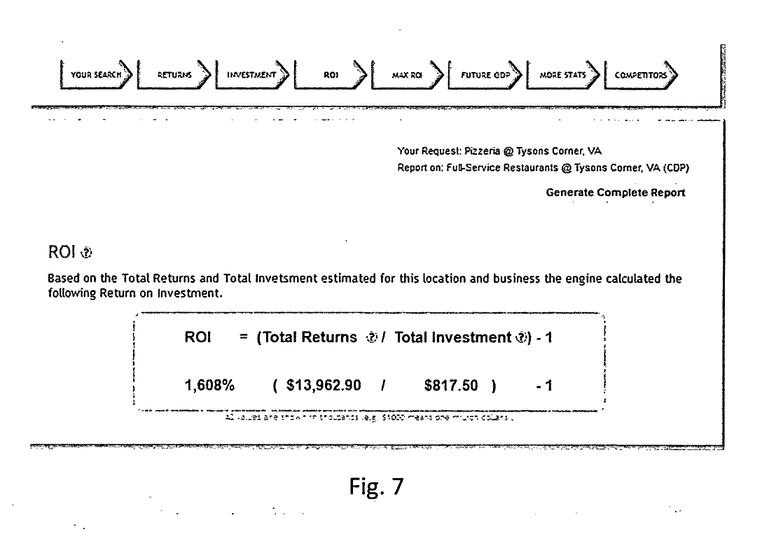

The user can continue interacting with the environment 100, by selecting the “ROI” button. In response to selection of the “ROI” button, the engine 130 can be programmed to compute the return on investment (ROI) for the selected business type in the selected location (ROI=(Total Returns/Total Investment)−1). A GUI showing the ROI is shown in FIG. 7.

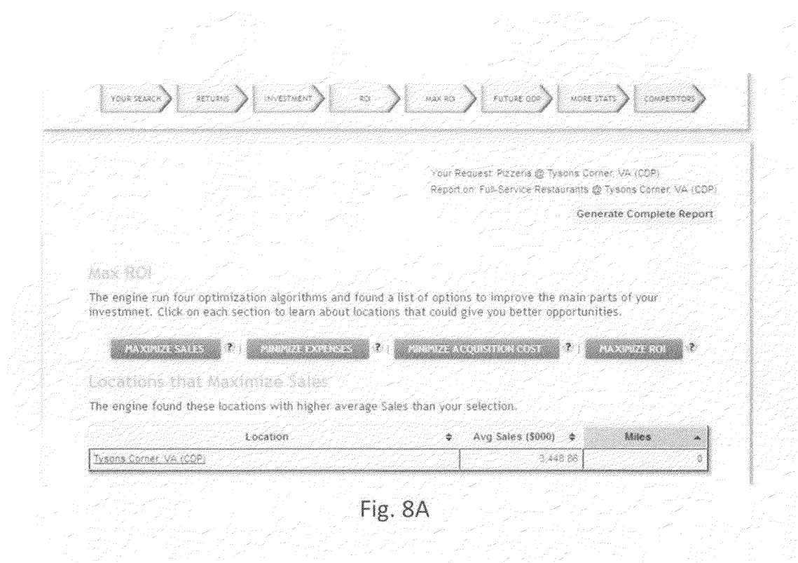

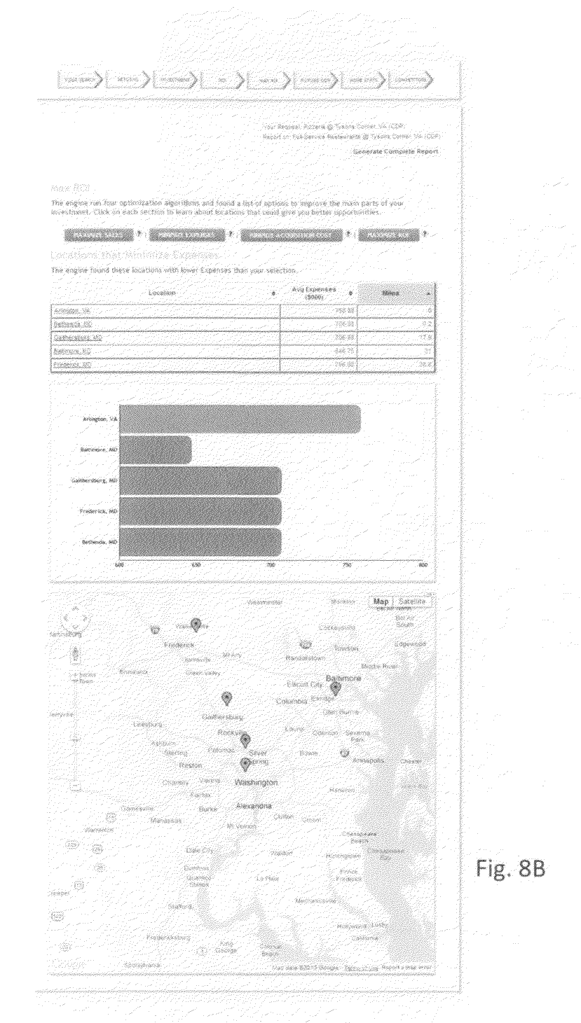

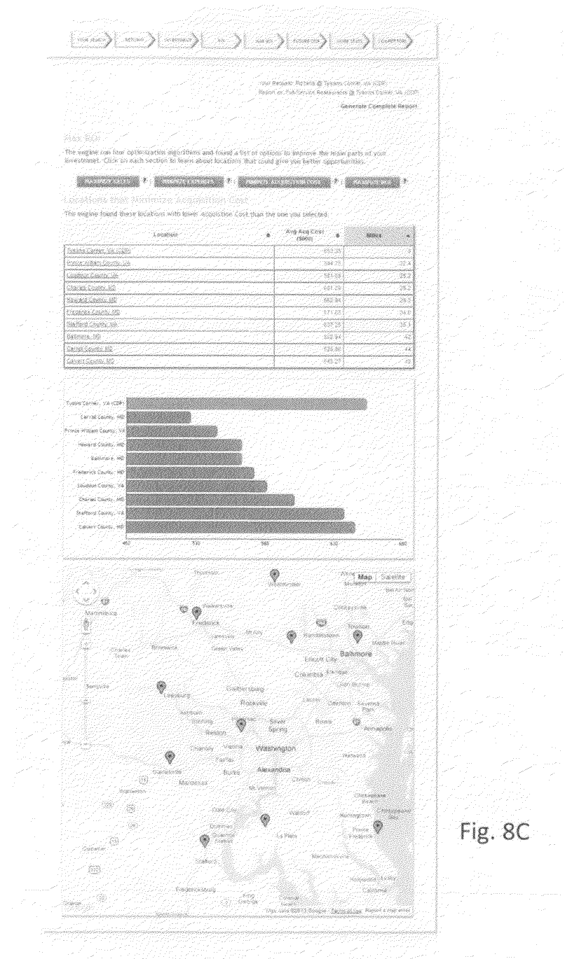

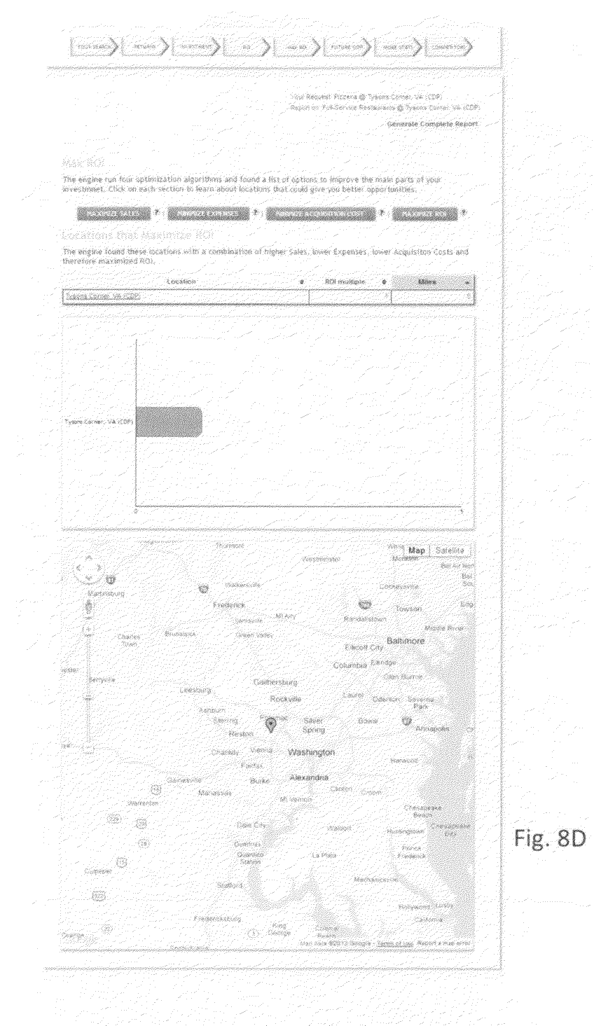

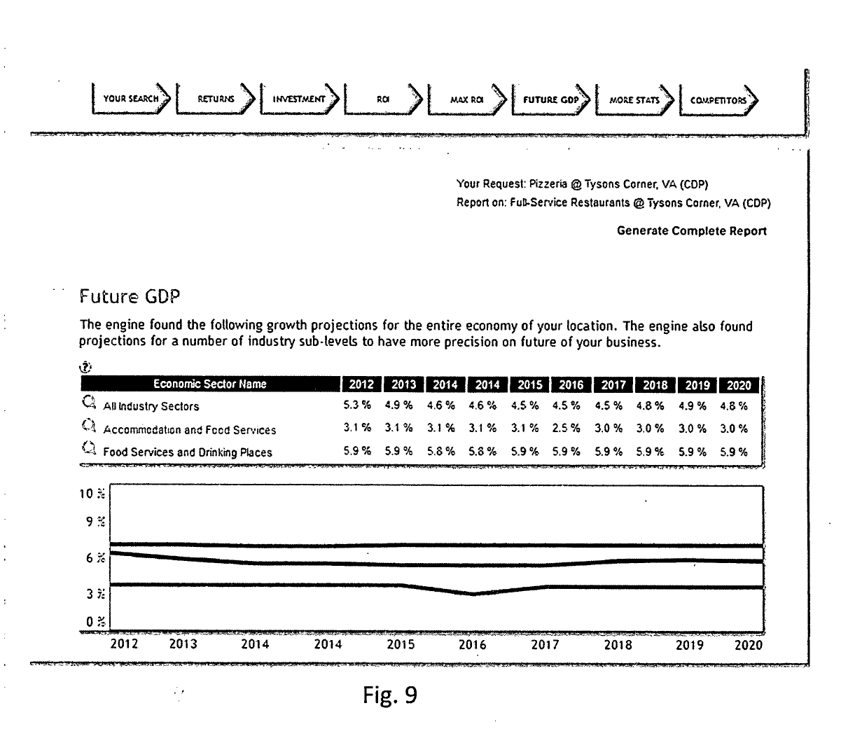

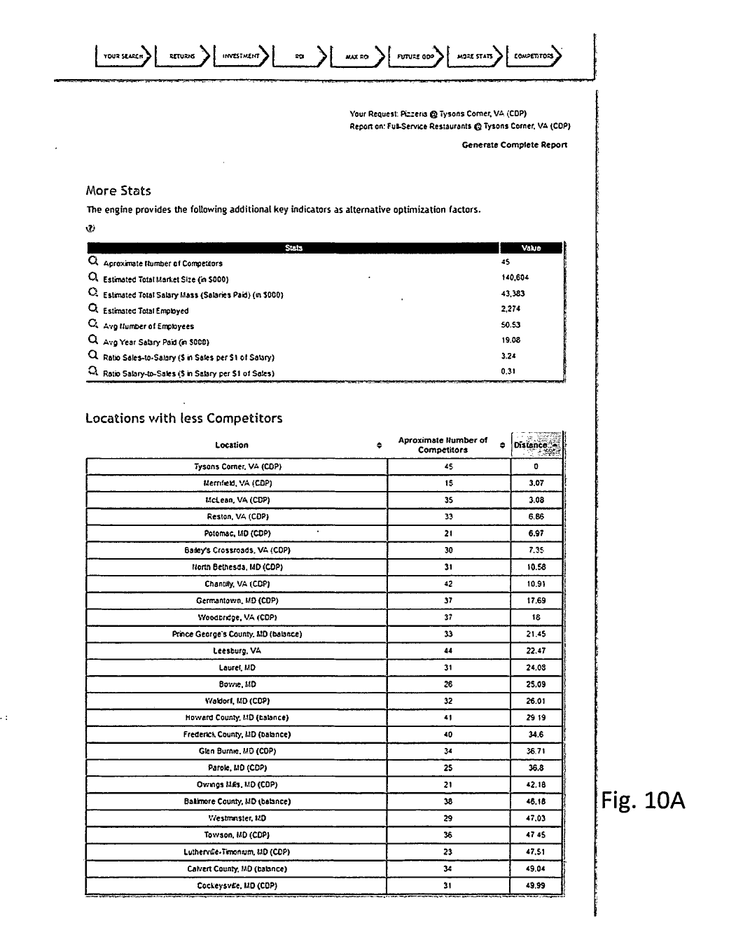

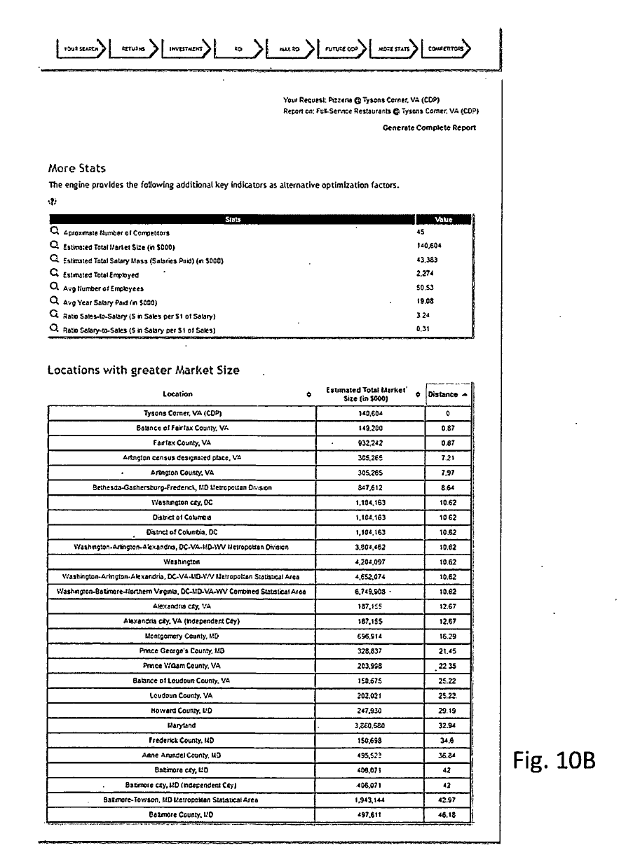

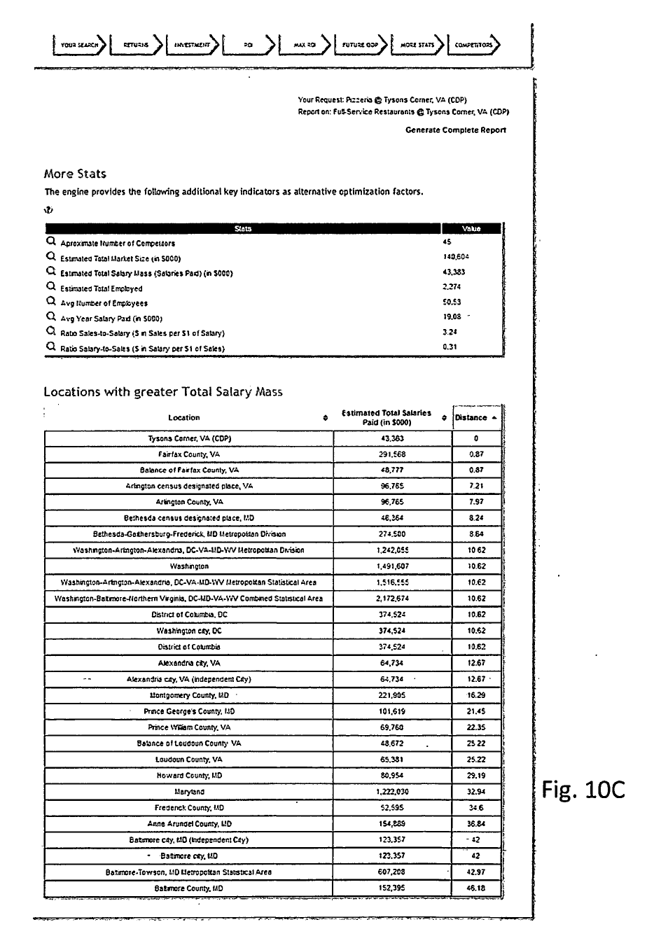

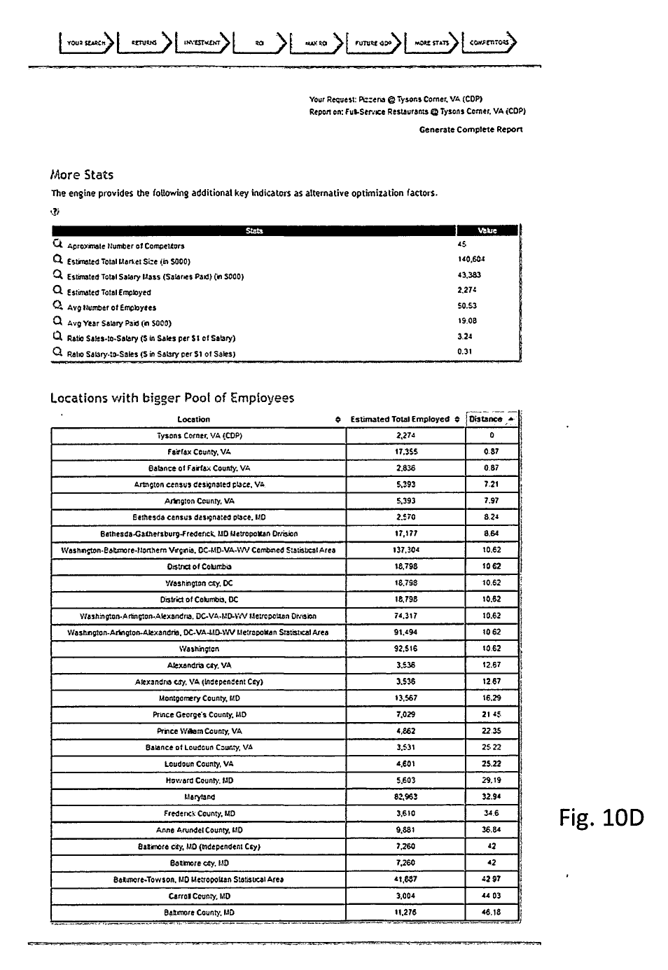

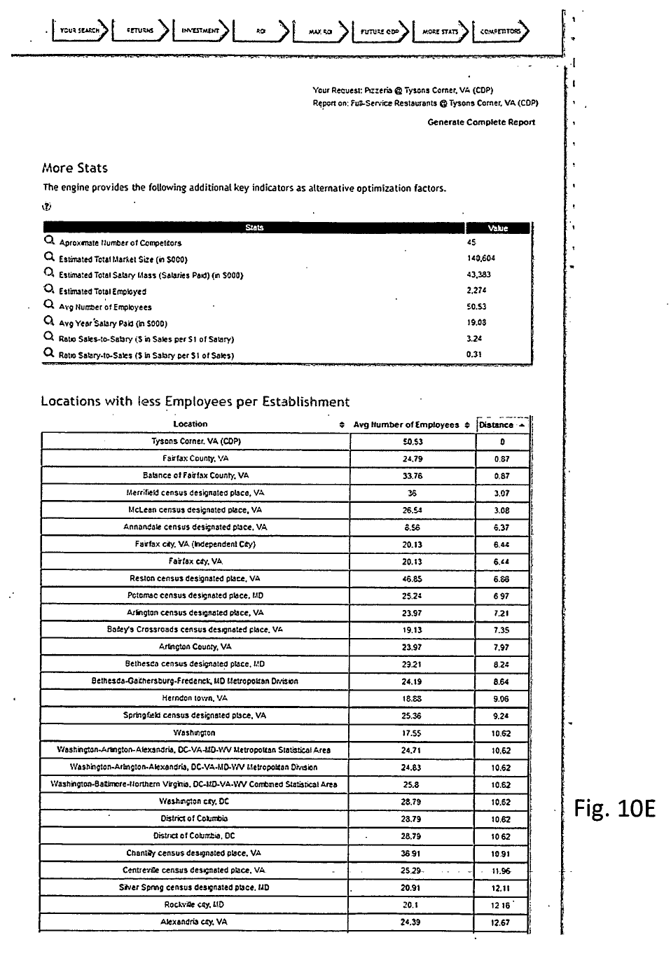

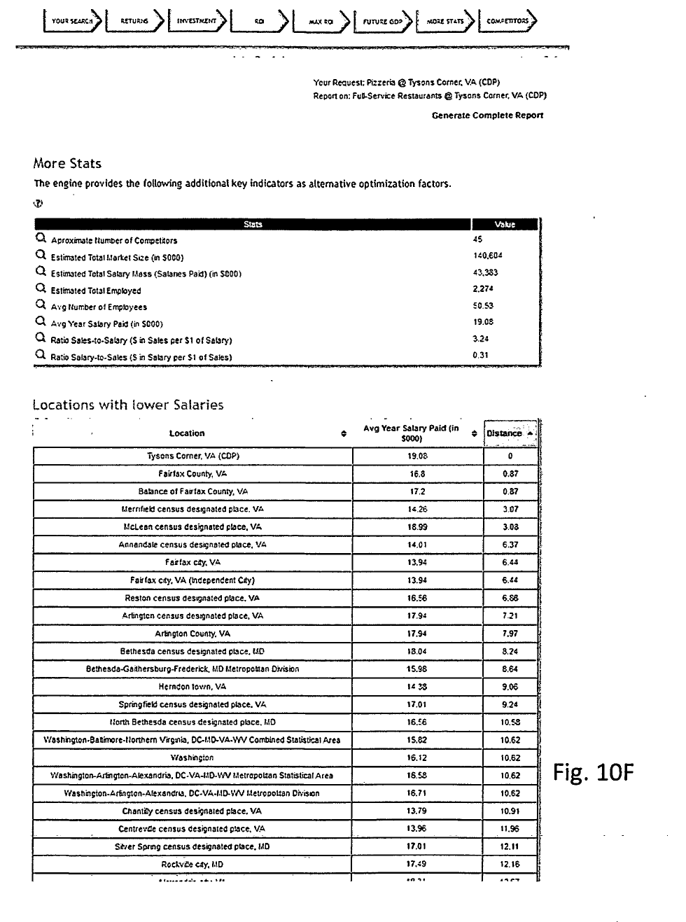

The user can continue interacting with the environment 100, by selecting the “MAX ROI” button. In response to selection of the “MAX ROI” button, the GUI shown in FIG. 8A is displayed to the user. The engine 130 can programmatically identify geographic locations within a specified distance (e.g., 50 miles) to the selected location for which the sales data is maximized (FIG. 8A), the expenses data is minimized (FIG. 8B), and the acquisition cost is minimized (FIG. 8C) in response to selection of the “Maximize Sales” button, the “Minimize Expenses” button, and the “Minimize Acquisition Cost” button, respectively. Additionally, the engine 130 can identify the geographic location with the geographic area corresponding to the selected location for which the ROI is maximized (FIG. 8D) in response to selection of the “Maximize ROI” button.

In one embodiment, the engine 130 can be programmed to generate a normalized ROI index based on the ROI of the selected geographic location. For example, the engine 130 can programmatically compute a difference between the average sales of a geographic location for one year (e.g., the preceding year) and the average expenses of the geographic location for one year (e.g., the preceding year). The difference is divided by the average acquisition cost of a geographic location for one year (e.g., the preceding year) to generate an ROI ratio. To identifier geographic locations that have a higher ROI ratio, generally reflecting a higher ROI, the engine 130 determines the ROI ratio for the selected geographic area and normalizes the ratio to one (1).

Using the normalized ROI ratio for the selected geographic location, in one embodiment, the engine 130 can generate a normalized ratio for geographic locations within a specified distance of the selected geographic location and can compare this ratio to the normalized ROI ratio for the selected geographic location. If the normalized ROI ratios for any geographic locations exceed the normalized ratio for the selected geographic location, the engine returns those geographic locations for display to the user via the GUI shown in FIG. 8D.

Using the normalized ROI ratio for the selected geographic location, in one embodiment, the engine 130 can programmed to generate a table of geographic location within a specified distance. The table can include for example average sales for one year (e.g., the preceding year), average expenses for one year (e.g., the preceding year), and an average acquisition cost for one year (e.g., the preceding year) for each geographic location in the table. Once the table is created, the engine 130 can programmatically compare the average sales data for each geographic location to the selected location and can remove geographic locations from the table that have lower average sales data than the selected geographic location. Likewise, the engine 130 can programmatically compare the average expenses data for each geographic location to the selected location and can remove geographic locations from the table that have higher average expenses data than the selected geographic location. In some embodiments, the engine 130 can programmatically compare the average acquisition cost data for each geographic location to the selected location and can remove geographic locations from the table that have higher average acquisition cost data than the selected geographic location. After the geographic location that do not satisfy one or more of the above criteria are removed from the table, the engine programmatically calculates the normalized ROI ratio for each geographical location in the table and can provide this data to the user via the GUI shown in FIG. 8D. The below table illustrates a table that can be prepared by the engine 130 to include only those geographic locations that have the higher sales, lower expenses, and lower acquisition cost than the selected geographic location.

| Id | c1 | c2 | c3 | c4 | c5 | c6 | c7 | c8 | c9 | c10 |
|---|---|---|---|---|---|---|---|---|---|---|
| 1 | Arlington | 1.00000 | 0 | Original | 38.88 | −77.1068 | E6000US5101303000 | 1497.56222 | 758.87763 | 653.35000 |
| | census | | | | | | | | | |
| | designated | | | | | | | | | |
| | place, VA | | | | | | | | | |
| 3 | North | 3.23147 | 11.3719 | Improved | 39.0446 | −77.1189 | E6000US2403156337 | 3093.91575 | 706.87745 | 653.35000 |
| | Bethesda | | | | | | | | | |
| | census | | | | | | | | | |
| | designated | | | | | | | | | |
| | place, MD | | | | | | | | | |
| 4 | Reston | 2.65532 | 14.0325 | Improved | 38.9687 | −77.3411 | E6000US5105966672 | 2668.31939 | 706.87745 | 653.35000 |
| | census | | | | | | | | | |
| | designated | | | | | | | | | |
| | place, VA | | | | | | | | | |
| 8 | Columbia | 2.11952 | 25.9937 | Improved | 39.203 | −76.858 | E6000US2402719125 | 1995.75694 | 646.75224 | 562.94000 |
| | census | | | | | | | | | |
| | designated | | | | | | | | | |
| | place, MD | | | | | | | | | |
| 7 | Parole | 1.98128 | 30.6852 | Improved | 38.9842 | −76.5531 | E6000US2400360325 | 2110.28899 | 646.75224 | 653.35000 |
| | census | | | | | | | | | |
| | designated | | | | | | | | | |
| | place, MD | | | | | | | | | |
| 9 | Owings | 1.78754 | 41.147 | Improved | 39.4195 | −76.7803 | E6000US2400559425 | 1967.18187 | 646.75224 | 653.35000 |
| | Mills | | | | | | | | | |
| | census | | | | | | | | | |
| | designated | | | | | | | | | |
| | place, MD | | | | | | | | | |
| 10 | Balance of | 1.75449 | 30.4871 | Improved | 38.953 | −76.5488 | E6000US2400398003 | 1960.75831 | 646.75224 | 662.42000 |
| | Anne | | | | | | | | | |
| | Arundel | | | | | | | | | |
| | County, | | | | | | | | | |
| | MD | | | | | | | | | |
| 12 | Glen | 1.74661 | 32.4512 | Improved | 39.1626 | −76.6247 | E6000US2400332650 | 1936.94173 | 646.75224 | 653.35000 |
| | Bumie | | | | | | | | | |
| | census | | | | | | | | | |
| | designated | | | | | | | | | |
| | place, MD | | | | | | | | | |

Columns c1, and c2 in the above table can be used to create one or more charts for display via the GUI. Column c1 contains names of geographic locations, column c2 contains number of times improved ROI ratio is better than original (e.g., for the second row in the table, the normalized ROI ratio is 3.23, which indicates that the ROI in that geographic location may be 3.23 times better than the selected geographic location (from row one having a normalized ROI ratio of 1). Columns c5 and c6 contain latitude and longitude data, which can be used by the engine to prepare a map showing the locations in the table. The map can show the selected location using a red marker and geographical locations offering an improved ROI can be shown using a blue marker. Column c4 includes a flag to indicate whether the row corresponds to an original (selected) geographic location or an improved location, which can correspond to a binary 1 or zero, respectively. Column c7 includes the unique geographic identifier for each geographic location. Columns 8-10 provide the average sales data, the average expenses data, and the average acquisition cost data, respectively.

Using the above table as an example, to normalize the ROI ratio for the selected location, the engine can compute the difference between the sales data and the expenses data (e.g., 1497.56222−758.87763) and can divide the difference by the acquisition cost (e.g., 738.685/653.35) to generate the raw ROI ratio (e.g., ˜1.13). The raw ROI ratio for the selected location is then normalized to one.

Using the above table as an example again, to normalize the ROI ratio for another geographic location, the engine 130 programmatically performs the same computations described above on the data associated with the other geographic location. For example, for the second row in the above table the raw Ratio=(3093.91575−706.87745)/653.35=−3.65. To normalize the ROI ratio, the engine divides the raw ROI ratio by 1.13, which results in a normalized ROI ratio of ˜3.23, as shown in column c2, row 2 of the above table.

The user can continue interacting with the environment 100, by selecting the “Future GDP” button. In response to selection of the “Future GDP” button, the engine 130 can retrieve growth projections for the selected geographic location (e.g., based on the latitude and longitude) including growth projections for all industry sectors, and industry sub-levels related to the selected business type. In some embodiments, if the GDP is not available, the engine can programmatically identify a geographic location in proximity to the selected geographic location. In some embodiments, the engine 130 can be programmed to allow a user to search for locations having a higher GDP than the selected geographic location within a specified distance. A GUI showing the projected GDPs is shown in FIG. 9.

The user can continue interacting with the environment 100, by selecting the “More Stats” button. In response to selection of the “More Stats” button, the engine 130 can be programmed to allow a user to view more statistics including, for example, competitor information, market information, total salary mass, total employed, average number of employees, average yearly salary paid, ratio of sales-to-salary (or sales-to-salary).

The user can select the “Approximate Number of Competitors” button and the engine 130 can be programmed to retrieve competitor information from one of the databases 120 for the selected geographic location and the other geographic location within a specified geographic distance (e.g., 50 miles) to display a list of geographic locations that have less competitor in a GUI (FIG. 10A).

The user can select the “Estimated Total Market Size” button and the engine 130 can be programmed to retrieve market size information from one of the databases 120 for the selected geographic location and the other geographic location within a specified geographic distance (e.g., 50 miles) to display a list of geographic locations that have a greater market size (FIG. 10B).

The user can select the “Estimated Total Salary Mass” button and the engine 130 can be programmed to retrieve the total salary information from one of the databases 120 for the selected geographic location and the other geographic locations within a specified geographic distance (e.g., 50 miles) to display a list of geographic locations that have a greater total salary mass (FIG. 10C).

The user can select the “Estimated Total Employed” button and the engine 130 can be programmed to retrieve the total estimated employed information from one of the databases 120 for the selected geographic location and the other geographic locations within a specified geographic distance (e.g., 50 miles) to display a list of geographic locations that have a larger pool of employees (FIG. 10D).

The user can select the “Average Number of Employees” button and the engine 130 can be programmed to retrieve employee per establishment information from one of the databases 120 for the selected geographic location and the other geographic locations within a specified geographic distance (e.g., 50 miles) to display a list of geographic locations that have less employees per establishment (FIG. 10E).

The user can select the “Average Year Salary Paid” button and the engine 130 can be programmed to retrieve average yearly salary information from one of the databases 120 for the selected geographic location and the other geographic locations within a specified geographic distance (e.g., 50 miles) to display a list of geographic locations that have lower average yearly salary paid (FIG. 10F).

The user can select the “Ratio Sales-to-Salary” button and the engine 130 can be programmed to retrieve sales-to-salary information from one of the databases 120 for the selected geographic location and the other geographic locations within a specified geographic distance (e.g., 50 miles) to display a list of geographic locations that have higher sales-to-salary ratios (FIG. 10G).

The user can select the “Ratio Salary-to-Sales” button and the engine can be programmed to retrieve salary-to-sales ratio information from one of the databases 120 for the selected geographic location and the other geographic locations within a specified geographic distance (e.g., 50 miles) to display a list of geographic location that have lower salary-to-sales ratios (FIG. 10H).

FIG. 11 is a block diagram of an exemplary computing device 1100 that may be used to implement exemplary embodiments of the front end reservation system 102 and/or the back end reservation system 104 described herein. The computing device 1100 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1106 included in the computing device 1100 may store computer-readable and computer-executable instructions or software for implementing exemplary embodiments of the front end reservation system 102 and/or the back end reservation system 104. The computing device 1100 also includes configurable and/or programmable processor 1102 and associated core 1104, and optionally, one or more additional configurable and/or programmable processor(s) 1102′ and associated core(s) 1104′ (for example, in the case of computer systems having multiple processors/cores), for executing computer-readable and computer-executable instructions or software stored in the memory 1106 and other programs for controlling system hardware. Processor 1102 and processor(s) 1102′ may each be a single core processor or multiple core (1104 and 1104′) processor.

Virtualization may be employed in the computing device 1100 so that infrastructure and resources in the computing device may be shared dynamically. A virtual machine 1114 may be provided to handle a process running on multiple processors so that the process appears to be using only one computing resource rather than multiple computing resources. Multiple virtual machines may also be used with one processor.

Memory 1106 may include a computer system memory or random access memory, such as DRAM, SRAM, EDO RAM, and the like. Memory 1106 may include other types of memory as well, or combinations thereof.

A user may interact with the computing device 1100 through a visual display device 1118, such as a computer monitor, which may display one or more graphical user interfaces 112 that may be provided in accordance with exemplary embodiments. The computing device 1100 may include other I/O devices for receiving input from a user, for example, a keyboard or any suitable multi-point touch interface 1108, a pointing device 1110 (e.g., a mouse), a microphone 1128, and/or an image capturing device 1132 (e.g., a camera or scanner). The keyboard 1108 and the pointing device 1110 may be coupled to the visual display device 1118. The computing device 1100 may include other suitable conventional I/O peripherals.

The computing device 1100 may also include one or more storage devices 1124, such as a hard-drive, CD-ROM, or other computer readable media, for storing data and computer-readable instructions and/or software that implement exemplary embodiments of the front end reservation system 102 and/or the back end reservation system 104 described herein. Exemplary storage device 1124 may also store one or more databases for storing any suitable information required to implement exemplary embodiments. For example, exemplary storage device 1124 can store one or more databases 1126 for storing information, such as product information including, for example, product specific information, product inventory information, product location information, and/or any other information to be used by embodiments of the systems 102 and/or 104. The databases may be updated manually or automatically at any suitable time to add, delete, and/or update one or more items in the databases.

The computing device 1100 can include a network interface 1112 configured to interface via one or more network devices 1120 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 400 can include one or more antennas 1130 to facilitate wireless communication (e.g., via the network interface) between the computing device 1100 and a network. The network interface 1112 may include a built-in network adapter, network interface card, PCMCIA network card, card bus network adapter, wireless network adapter, USB network adapter, modem or any other device suitable for interfacing the computing device 1100 to any type of network capable of communication and performing the operations described herein. Moreover, the computing device 1100 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 1100 may run any operating system 1116, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1116 may be run in native mode or emulated mode. In an exemplary embodiment, the operating system 1116 may be run on one or more cloud machine instances.

FIG. 12 is a block diagram of an exemplary client-server environment 1200 configured to implement one or more embodiments of the environment 100. The environment 1200 includes servers 1210-1213 operatively coupled to clients 1220-1222, via a communication network 1250, which can be any network over which information can be transmitted between devices communicatively coupled to the network. For example, the communication network 1250 can be the Internet, an Intranet, virtual private network (VPN), wide area network (WAN), local area network (LAN), and the like. The environment 1200 can include repositories or databases 1230-1231, which can be operatively coupled to the servers 1210-1213, as well as to clients 1220-1222, via the communications network 1250. The servers 1210-1213, clients 1220-1222, and databases 1230-1231 can be implemented as computing devices. Those skilled in the art will recognize that the database devices 1230-1231 can be incorporated into one or more of the servers 1210-1213 such that one or more of the servers can include databases. In an exemplary embodiment, the environment 100 can be implemented by the servers 1210-1213 in conjunction with the client devices 1220-1222 and the databases 1230-1231, which can store information for use by the environment 100, as described herein. For example, in one embodiment, the engine 130 can be implemented by one or more of the servers 1210-1212 and the user interface can by implemented by the server 1213.

The client devices 1220-1222 can include a client side application 1223 programmed and/or configured to access or execute the front end system 102 to search for product/item information. In the present embodiment, the client devices 1220-1222 can be portable computing devices. In one embodiment, the client-side application 1223 implemented by the client device 1220 can be a web-browser capable of navigating to one or more web pages hosting GUIs of the environment 100 and the client-side application 1223 implemented by the client device 1221 can be a software application specific to the environment 100. In exemplary embodiments, the client devices 1220-1222 can be configured to communicate with the network 1250 via wired and/or wireless communication.

While the following disclosure generally illustrates an implementation of an exemplary embodiment of an economic modeling environment in the field of business investments (e.g., starting, acquiring, expanding, etc. a business), those skilled in the art will recognize that exemplary embodiments of the environment can advantageously be implemented in other fields in accordance with the present disclosure. For example, exemplary embodiments of the environment can also be implemented in, but not limited to the fields of real estate investments (e.g., residential or commercial property investments) and consumer/commercial purchase expenses (e.g., vehicle purchases).

In the field of real estate investing, an embodiment of the environment can provide one or more location specific reports to provide the user with information that can be used when determining whether to purchase real estate in one geographic location or another geographic location. For example, using the processes described herein embodiments of the environment can store real estate and economic data in one or tables of an embodiment of the databases 120 and the tables can be link using semantic text index to identify rows of corresponding data in different tables and/or can use geographic services to generate and incorporate a latitude and longitude in the tables of the databases as described herein. An environment 100 can provide one or more GUI that allow user to enter information (e.g., a description of the real estate of interest and a geographic location) and an embodiment of the engine 130 can be programmed to retrieve and/or analyse data that can be presented to the user in one or more reports including, for example, a cost of purchasing real estate, potential rental income, economic growth, return on investment, maintenance expenses, and so on, which can be presented for a selected geographic location as well as for other geographic locations. The engine 130 can also be programmed to identify locations having higher or lower data values that can influence the users decision making process in a similar manner as described herein.

Likewise, in the field of purchasing expenses (e.g., vehicle purchases), the environment can an embodiment of the environment can provide one or more location specific reports to provide the user with information that can be used when determining whether to purchase vehicle in one geographic location or another geographic location. For example, using the processes described herein embodiments of the environment can store vehicle information and economic data in one or tables of an embodiment of the databases 120 and the tables can be link using semantic text index to identify rows of corresponding data in different tables and/or can use geographic services to generate and incorporate a latitude and longitude in the tables of the databases as described herein. An environment 100 can provide one or more GUI that allow user to enter information (e.g., a description of the vehicle of interest and a geographic location) and an embodiment of the engine 130 can be programmed to retrieve and/or analyse data that can be presented to the user in one or more reports including, for example, a cost of purchasing a type of vehicle, potential resale value, economic growth, maintenance expenses, and so on, which can be presented for a selected geographic location as well as for other geographic locations. The engine 130 can also be programmed to identify locations having higher or lower data values that can influence the users decision making process in a similar manner as described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A method for generating one or more electronic reports for a field of interest comprising:
receiving parameters from a user, the parameters including a descriptive term for the field of interest and a location information for the field of interest;
identifying a field of interest by programmatically comparing the descriptive term to fields of interest in a database;
converting the location information to a latitude value and longitude value to associate the location information with a geographic location;
identifying other geographic locations within a specified distance of the geographic location based the latitude value and longitude value of the geographic location and a latitude value and longitude value of each of the other geographic locations; and
programmatically generating at least one of a financial report or an economic report including at least one of historic data or projected data for the geographic location and the other geographic locations.

2. The method of claim 1, wherein identifying other geographic locations within a specified distance of the geographic location comprises identifying the other geographic locations in response to criteria associated with the data of the other geographic locations.

3. The method of claim 2, further comprising displaying the other geographic locations that satisfy the criteria to the user.

4. The method of claim 3, wherein the data comprises sales data and the criteria comprises a threshold for the sales data, the other geographic locations having sales data that is greater than the threshold being displayed to the user.

5. The method of claim 3, wherein the data comprises expenses data and the criteria comprises a threshold for the expenses data, the other geographic locations having expenses data that is less than the threshold being displayed to the user.

6. The method of claim 3, wherein the data comprises acquisition cost data and the criteria comprises a threshold for the acquisition cost data, the other geographic locations having acquisition cost data that is less than the threshold being displayed to the user.

7. The method of claim 3, wherein the data is associated with a return on investment and the criteria comprises a threshold for the data, the other geographic locations having a return on investment that is greater than the threshold being displayed to the user.

8. The method of claim 1, further comprising:
determining that the at least one of historic or project data is unavailable for the geographic location; and
programmatically generating the at least one of historic data or projected data for the geographic location based on data associated with at least one of a county within which the geographic location is located, a state within which the geographic location is located, a country within which the geographic location is located, or another geographic location located within a specified distance to the geographic location.

9. The method of claim 8, wherein programmatically generating the at least one of historic data or projected data for the geographic location comprises performing a cost of living adjustment to the data associated with at least one of a county within which the geographic location is located, a state within which the geographic location is located, a country within which the geographic location is located, or another geographic location located within a specified distance to the geographic location.

10. The method of claim 1, further comprising:
determining that the at least one of historic or project data is unavailable for the geographic location for one or more years; and
programmatically generating the at least one of historic data or projected data for the geographic location for the one or more years based on data associated with the geographic location for other years.

11. The method of claim 10, wherein programmatically generating the at least one of historic data or projected data for the geographic location for the one or more years comprises performing an adjustment to the data associated with the geographic location for other years based on inflation.

12. A system for generating one or more electronic reports for a field of interest comprising:
a non-transitory computer readable media storing instructions for generating at least one of a financial report or an economic report; and
a processing device programmed to execute the instructions to:
receiving parameters from a user, the parameters including a descriptive term for the field of interest and a location information for the field of interest;
identifying a field of interest by programmatically comparing the descriptive term to fields of interest in a database;
converting the location information to a latitude value and longitude value to associate the location information with a geographic location;
identifying other geographic locations within a specified distance of the geographic location based the latitude value and longitude value of the geographic location and a latitude value and longitude value of each of the other geographic locations; and
programmatically generating at least one of a financial report or an economic report including at least one of historic data or projected data for the geographic location and the other geographic locations.

13. A non-transitory computer-readable medium storing instruction that are executable by a processing device, wherein execution of the instructions causes the processing device to perform a method for generating one or more electronic reports for a field of interest comprising:
reading instructions for receiving parameters from a user, the parameters including a descriptive term for the field of interest and a location information for the field of interest;
reading instructions for identifying a field of interest by programmatically comparing the descriptive term to fields of interest in a database;
reading instructions for converting the location information to a latitude value and longitude value to associate the location information with a geographic location;
reading instructions for identifying other geographic locations within a specified distance of the geographic location based the latitude value and longitude value of the geographic location and a latitude value and longitude value of each of the other geographic locations; and
reading instructions for programmatically generating at least one of a financial report or an economic report including at least one of historic data or projected data for the geographic location and the other geographic locations.
